(19) United States
(12) Patent Application Publication
(10) Pub. No.: US 2007/0192167 A1
(43) Pub. Date: Aug. 16, 2007

(54) Methods and systems for managing transaction card customer accounts

(76) Inventors: Ying Lei, Millburn, NJ (US); Iho Chen, Edison, NJ (US); Echo Liang, Short Hills, NJ (US)

Correspondence Address: KILPATRICK STOCKTON LLP, 607 14TH STREET, N.W., WASHINGTON, DC, 20005, US

(21) Appl. No.: 11/584,280

(22) Filed: Oct. 20, 2006

Related U.S. Application Data
(60) Provisional application No. 60/729,174, filed on Oct. 24, 2005.

(51) Int. Cl. G07G 1/00; G06F 17/30

(52) U.S. Cl. 705/10

(57) ABSTRACT

Methods and systems for managing transaction card customer accounts provided by a financial institution for a plurality of customers involves dividing the plurality of accounts into a plurality of predefined customer value segments by the financial institution and identifying accounts in each of the customer value segments that exhibits characteristics indicative of a trend towards an inactive state of the account. Thereafter, accounts are selected from among the accounts identified as trending towards the inactive state to be evaluated for marketing efforts based at least in part on the customer value segment of the accounts, and the selected accounts are then analyzed to determine a type of marketing effort for each account.

### PRIORITY APPLICATION

This application claims the benefit of U.S. Provisional Application No. 60/729,174 filed Oct. 24, 2005, entitled “PROACTIVE SALES MANAGEMENT” and incorporated herein by this reference

### FIELD OF THE INVENTION

The present invention relates generally to the field of transaction cards, and more particularly to methods and systems for managing transaction card customer accounts.

### BACKGROUND OF THE INVENTION

In order to remain competitive in the marketplace and to achieve sustainable long term profitable growth, issuers of transaction cards, such as credit cards, have a compelling need to understand the process by which customers become disengaged from the credit card issuer's products and services over time and to use that information to manage credit card customers. Currently, the credit card issuer will only notice disengagement of the customer from the issuer's services close to or after the fact, at which point intervention to re-engage the customer is less likely to succeed. Accordingly, there is a current need for methods and systems for managing transaction card customer accounts that enable a card issuer to identify accounts that are likely to become inactive and to evaluate what, if any, intervention is warranted to attempt to prevent such inactivity from occurring

### SUMMARY OF THE INVENTION

It is a feature and advantage of the present invention to provide methods and systems for managing transaction card customer accounts that enables a card issuer to gain an in-depth understanding of the process by which customers become disengaged from the issuer's products and services over time.

It is a further feature and advantage of the present invention to provide methods and systems for managing transaction card customer accounts that enables the card issuer to identify at an earlier point in time the customers at risk of becoming disengaged and to assess the degree of urgency for intervening to re-engage the customer, for example, by proactively managing customers' card usage.

It is another feature and advantage of the present invention to provide methods and systems for managing transaction card customer accounts that enables the card issuer to identify which customers at risk of disengagement should be proactively managed, when and how to manage such customers, and how much to invest in the management effort.

It is an additional feature and advantage of the present invention to provide methods and systems for managing transaction card customer accounts that enables the card issuer to segment customers by their preference and/or usage in order to evaluate their potential business income contribution to the card issuer.

It is a still feature and advantage of the present invention to provide methods and systems for managing transaction card customer accounts that enables the card issuer to evaluate the opportunity cost when customers depart from their normal card usage behavior as a factor in evaluating investment priorities.

To achieve the stated and other features, advantages and objects, embodiments of the present invention employ computer hardware and software, including, without limitation, instructions embodied in program code encoded on machine readable medium, to provide methods and systems for managing transaction card customer accounts provided by a financial institution for a plurality of customers which involves dividing the plurality of accounts, for example, into a plurality of predefined customer value segments by the financial institution and identifying accounts in each of the customer value segments that exhibits characteristics indicative of a trend towards an inactive state of the account. Thereafter, accounts are selected from among the accounts identified as trending towards the inactive state to be evaluated for marketing efforts based at least in part on the customer value segment of the accounts, and the selected accounts are then analyzed to determine a type of marketing effort for each account.

According to embodiments of the invention, the accounts are divided into the plurality of predefined customer value segments based at least in part on a potential value of each customer's account to the financial institution according to predefined parameters, including for example, a predefined potential business income contribution to the financial institution from each customer's account. For example, the accounts are divided into the customer value segments based at least in part on how often a customer uses the customer's account in a predetermined time period. In embodiments of the invention, the customer value segments into which the accounts are divided consist at least in part of a predefined transactor segment of customers who use their transactions cards for sales and pay their balances in full and a predefined revolver segment who do not pay their balances in full and carry a balance on their account.

In other embodiments of the invention, the customer value segments also include, for example, occasional revolvers characterized by customers who alternate between paying their balance in full and revolving their balance. In still other embodiments, the customer value segments include, for example, high risk customers, new accounts, severely inactive accounts, self-activated accounts, balance consolidation gamers, and occasional revolvers. In embodiments of the invention, each account in at least the transactor and revolver segments is assessed, for example, as a high value customer if the customer uses the customers' account at least five months in a six months period, a mid value customer if the customer uses the customer's account for two to four months in a six months period, or a low value customer if the customer uses the customer's account for one or fewer months in a six months period.

Identifying the accounts exhibiting characteristics indicative of a trend towards an inactive state according to embodiments of the invention involves, for example, identifying accounts in each of the customer value segments exhibiting a change in a level of sales, preferably as a function of time, that is indicative of a trend towards the inactive state and dividing the identified accounts into buckets based on levels of inactivity in each account ranging, for example, from statement inactivity for three consecutive months to sales levels varying less than one standard deviation from a mean for the account. In embodiments of the invention, the identification of such accounts should be done before they reach the inactive state.

According to embodiments of the invention, selecting the accounts to be evaluated for marketing efforts involves, for example, selecting the accounts from the predefined customer value segments consisting at least in part of the transactor segment of accounts of customers who use their transactions cards for sales and pay their balances in full and the revolver segment of customers who do not pay their balances in full and carry a balance on their account. In other embodiments, the accounts to be evaluated for marketing efforts are also selected from at least one additional predefined customer value segment consisting of the occasional revolvers segment of accounts characterized by customers who alternate between paying their balance in full and revolving their balance.

In embodiments of the invention, analyzing the selected accounts to determine a type of marketing effort for each account involves, for example, analyzing the accounts according to a matrix of at least the transactor and revolver customer segments, cross referenced with inactivity status and based on location onto the matrix of the customer's inactivity status and the customer's value segment. The choices of marketing efforts include, for example, a defend effort for customers representing value and profitability to the financial institution, a retain effort for customers formerly representing value and profitability to the financial institution but have changed their behavior and are thus no longer valuable and profitable to the financial institution, a grow effort for customers for whom there is overall credit usage growth over time, and an economize effort for customers who are not profitable and unlikely to become profitable to the financial institution.

Additional objects, advantages and novel features of the invention will be set forth in part in the description which follows, and in part will become more apparent to those skilled in the art upon examination of the following, or may be learned from practice of the invention.

### BRIEF DESCRIPTION OF THE DRAWINGS

FIG. 1 is a diagram that illustrates an example of an analysis of the path to statement inactive status for revolvers for embodiments of the invention;

FIGS. 2 and 3 are diagrams that illustrate examples of analysis of the path to sales and statement inactive status for revolvers for three and five months respectively for embodiments of the invention;

FIGS. 4 and 5 are diagrams that illustrate examples of analysis of the path of statement inactive; status for transactors for three and five months respectively for embodiments of the invention;

FIG. 6 is a table that illustrates examples of possible triggers for new balance consolidations and new off-us cards for embodiments of the invention;

FIG. 7 is a table that illustrates examples of inactivity buckets for embodiments of the invention;

FIG. 8 is a table which illustrates an example of customer value segments for embodiments of the invention;

FIG. 9 is a schematic diagram that illustrates an example of a transaction card customer life cycle for embodiments of the invention;

FIG. 10 is a table that illustrates examples of customer transaction patterns for embodiments of the invention;

FIG. 11 is a table that illustrates an example of customer value segments and subsegments eligible for proactive sales management for embodiments of the invention;

FIG. 12 is an example of a graphical illustration of appropriate strategies, based on an evaluation of customers' current and potential profitability, for embodiments of the invention;

FIG. 13 is a similar graphical illustration with legends representing each of defend, retain, grow, and economize for embodiments of the invention;

FIG. 14 is a graphical illustration of appropriate strategies for action by the credit card issuer for embodiments of the invention;

FIG. 15 is a table that illustrates examples of recommended strategies based on the analysis for embodiments of the invention; and

FIG. 16 is a flow chart that illustrates an example of the process of managing transaction card customer accounts for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used on another embodiment to yield a still further embodiment. Thus, it is intended that the present invention cover such modifications and variations that come within the scope of the invention.

Embodiments of the invention enable issuers of transaction cards, such as credit cards, to understand the process by which customers become disengaged from a credit card issuer's products and services over time, and to use this information to manage credit card customers. Embodiments of the invention include, for example, two components, a first of which is the identification of accounts likely to become inactive and the second of which is the evaluation, based on the value and credit usage pattern of the customer, of whether or not intervention by the issuer to prevent inactivity is warranted and, if so, what kind of intervention is warranted.

This evaluation of the potential value and usage pattern of customers according to embodiments of the invention may be referred to as placing customers in customer value segments. The segmentation aims to capture customers' distinct credit profiles, their usage and level of engagement with the issuer, as well as to capture the change of their preferences as a function of time so that timely and relevant products and services may be delivered to the customers. By capturing customers' usage and preference, the card issuer can be more assured of sustainable long term profitable growth and wallet share.

With typical present methods, a credit card issuer will typically notice disengagement of the customer from the issuer's services only close to or after the fact, at which point intervention to re-engage the customer is less likely to succeed. Methods of embodiments of the present invention can identify accounts likely to become inactive before they reach an inactive state, in particular, before they reach a “statement inactive state”, thus allowing the issuer time to intervene and preserve the issuer's future business income from the customer.

In one embodiment, “proactive sales management,” is therefore a method of early detection of incipient customer inactivity, also referred to herein as “disengagement”, and intervention by the issuer to re-engage the customer with the issuer's products and services before the customer has become fully disengaged from using the issuer's products and services. Analysis shows that at any given time, customers' inactivity or closure could be triggered by many factors, including the abundance of competitive offers from card issuers, branch and retail stores, as well as the issuer's own treatments and product offerings.

The complexity of these “triggers” or “counter-triggers” often confound the causal-effect of “triggers” versus inactivity occurrence. One purpose of embodiments of the present invention is not only to deal with modeling the impact of “triggers” but also to analyze the general path to eventual disengagement (i.e., “statement inactive”). This approach can therefore be called “path analysis”, sometimes referred to as such herein, and embodiments of the present invention constitute a dynamic view of customer disengagement, rather than a static one.

The identification of the path to inactivity (i.e., the velocity of preference change) according to embodiments of the invention enables the issuer, for example, to gain an in-depth understanding of the process by which customers become disengaged from the issuer's products and services over time, to identify at an earlier point in time the customers at risk of becoming disengaged, and to assess the degree of urgency for intervening to re-engage the customer (i.e., proactively managing customers' card usage). Therefore, embodiments of the present invention enable the card issuer to determine, for example, which of such customers should be proactively managed, when and how to contact and/or treat such customers, and how much to invest on customers at risk of disengagement.

The use of customer value segments to analyze customers for embodiments of the invention enables the issuer to: segment customers by their preference and/or usage, which leads to their potential business income contribution, to evaluate the opportunity cost to the issuer when customers depart from their normal card usage behavior, and to help the card issuer to prioritize investment priorities.

By way of terminology in embodiments of the invention, customers are classified both by how they use credit and how much they use credit. Customers who use their cards for sales and pay their balances in full are referred to herein as “transactors.” By comparison, customers who do not pay their balances in full (i.e., who carry a balance on their bills and are thus borrowing from the card issuer) are referred to as “revolvers.” Thus the transactor/revolver distinction describes how a customer uses credit. How often a customer uses the card in a given time period is referred to as the potential or potential engagement of the customer.

In embodiments of the invention, how customers use credit and how much they use credit is assessed on a monthly basis, so that, for example, if the customer uses the credit card at least five months in a six months period, the customer is considered to be a high-potential customer; if the customer uses the credit card for two to four months in a six months period, the customer is considered a medium-potential customer; and if the customer uses the credit card for one or fewer months in a six months period, the customer is considered a low-potential customer.

According to embodiments of the invention, a high-potential customer is therefore a customer who uses the card on a regular basis and who has a significant sales engagement level, which leads to long term balance growth. A medium-potential customer is a customer who uses the card on a semi-regular basis, and a low potential customer is a customer who rarely or never uses the card. Therefore, the high/medium/low potential distinguishes the frequency of a given customer's transactions.

With regard to customer inactivity, embodiments of the invention distinguish between “sales inactivity” wherein the customer has stopped using an issuer's credit card for purchases or cash advances within a given billing period, but may still have a balance on the account, and “statement inactivity” wherein the customer has no any activity of any kind on the account, such as sales, payments or other transactions, for a given billing period.

An aspect of embodiments of the invention involves analysis of account activity and identification of accounts likely to become inactive, which focuses at least in part on the path of how active customers would gradually become disengaged from the credit card issuer over time, and how the issuer can detect such disengagement at a stage early enough to permit effective intervention to re-engage the customer.

The future business income derived from credit cards can be statistically predicted with considerable accuracy, based on the usage patterns (i.e., transactor or revolver) and spending level or potential of the customer. If a customer's credit card usage diverges negatively from this norm, especially if it ultimately results in account inactivity, the reduction in income for the issuer is referred to as business opportunity cost. It is this business opportunity cost that embodiments of the present invention can assist an issuer in avoiding.

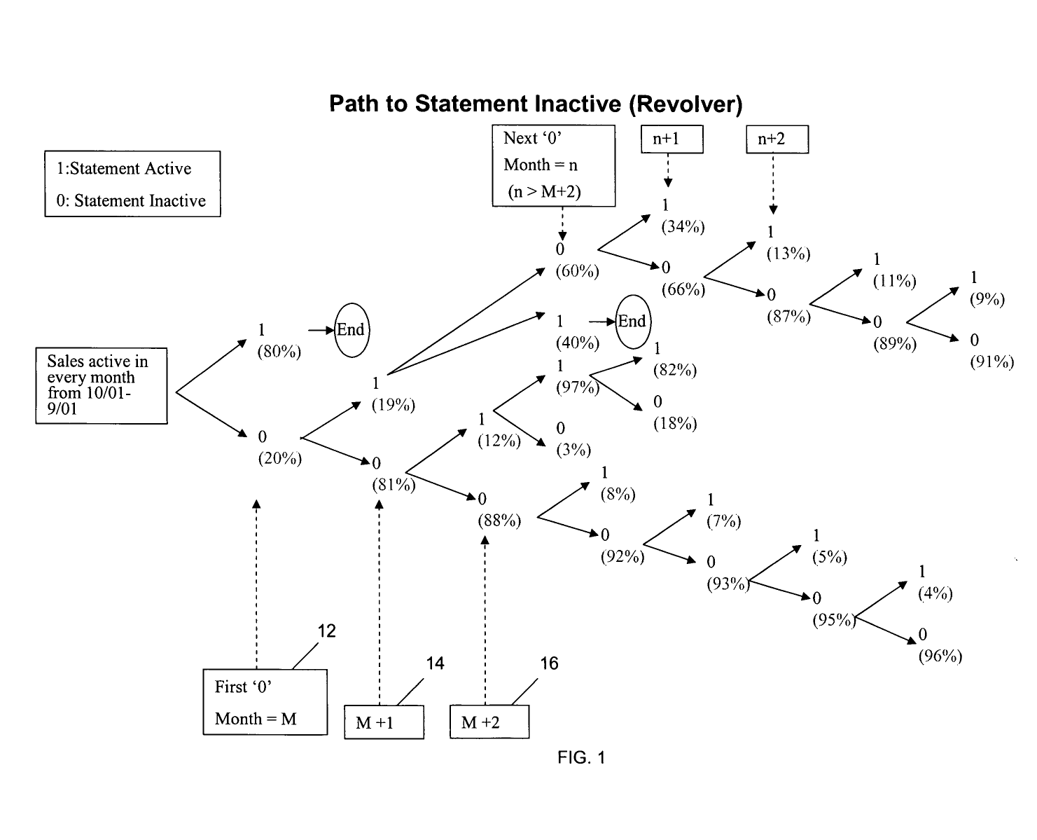

FIG. 1 is a diagram that illustrates an example of an analysis of the path to statement inactive status for revolvers for embodiments of the invention. Referring to FIG. 1, in an analysis using an embodiment of the invention, it was found that once a loyal customer has become disengaged (i.e., first statement inactive) 12, the roll-rate for two cycles in a row (i.e., M+1 or second inactivity) 14 is above 80%. In other words, once a customer has become statement inactive for one month, there is a greater than 80% probability that the customer will continue to be statement inactive the following month. The roll-rate to the third statement inactivity (M+2) 16 is close to 90%. The opportunity window of action then appears limited once a customer has become disengaged three billings in a row. A question that embodiments of the present invention sets out to address is then: what are the early “symptoms?”

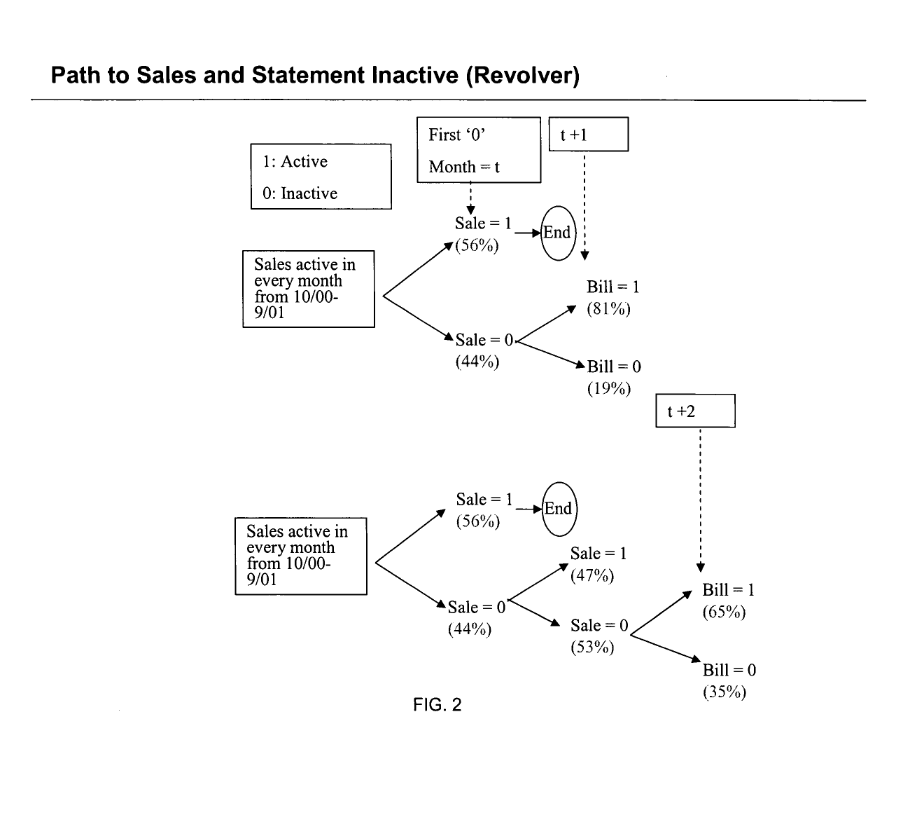

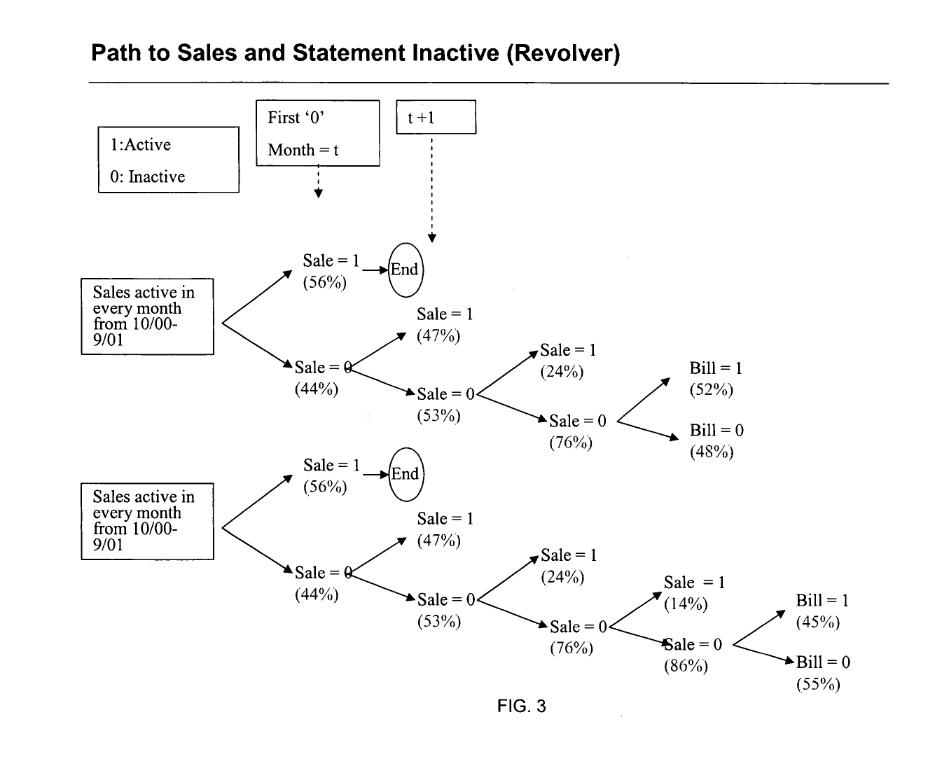

Sales inactivity predictably precedes statement inactivity. FIGS. 2 and 3 are diagrams that illustrate examples of analysis of the path to sales and statement inactive status for revolvers for three and five months respectively for embodiments of the invention. The length of the period between sales and statement inactivity can in part be predicted by customers' initial balances (i.e., paydown curve). Sales inactivity is often preceded by reduction in transaction frequencies as well as some rise in “other-issuer” activities, such as activities on cards issued by other financial institutions, which activities may also be referred to as “triggers.”

Therefore, the path of inactivity, from a very late stage (i.e., three months of statement inactivity in a row or “death”) to earlier months of sales variations and to acquisition of new accounts, can be generalized and managed. Embodiments of the invention comprise developing a dynamic view of how a credit card customer can become inactive and disengaged from using the credit card issuer's products and services.

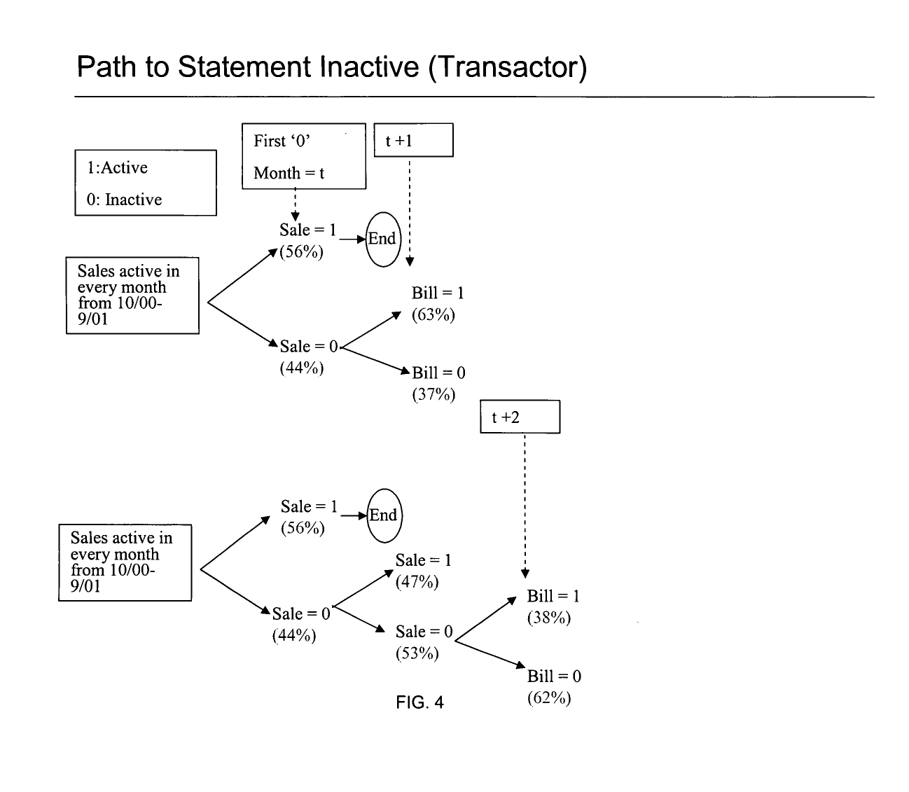

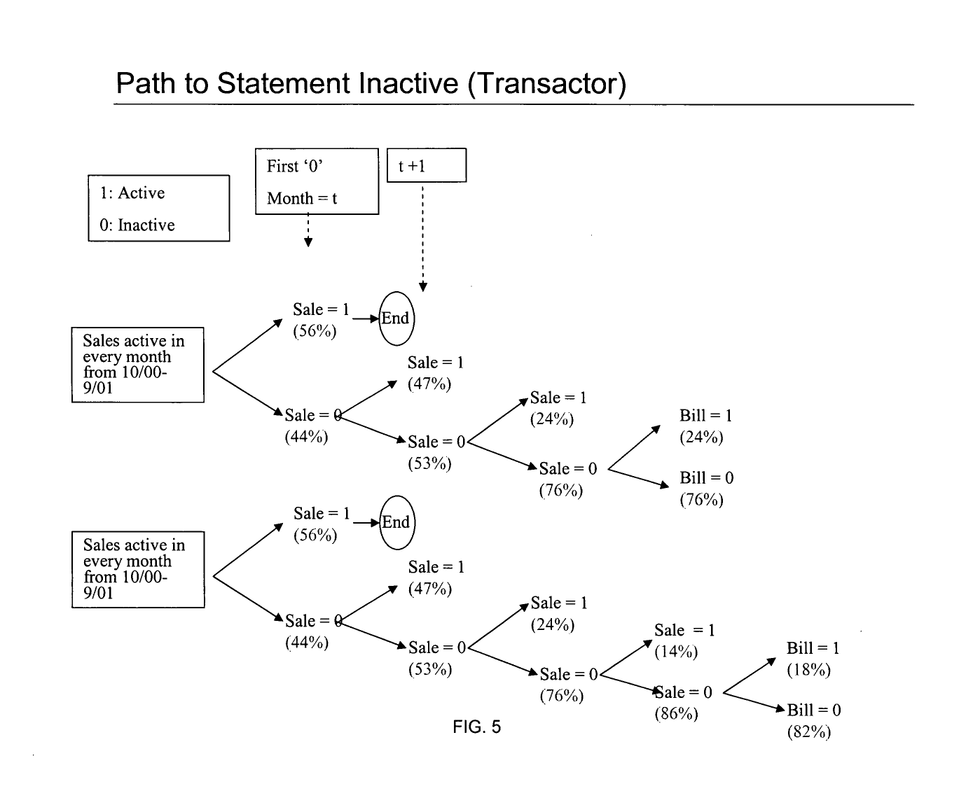

In some embodiments, due to customers' different credit card usage patterns (e.g., revolvers v. transactors), their paths to statement inactivity are modeled and described separately. FIGS. 4 and 5 are diagrams that illustrate examples of analysis of the path of statement inactive status for transactors for three and five months respectively for embodiments of the invention.

For “revolver” customers, the “sudden death” syndrome of statement inactivity (i.e., relatively quick progression to statement inactivity without sufficient time by the issuer to design and implement strategies to counter the inactivity) does not usually allow much reaction time. Therefore, it may be preferable to explore whether the statement inactivity is preceded by sales inactivity. Sales inactivity in general is often more volatile. On average, it takes three months of sales inactivity to get to the first statement inactivity.

Some initial time series data suggest that the length between sales inactivity and statement inactivity is related to the initial balance level. Intuitively, it would often take revolvers longer to pay down the balance before becoming statement inactive.

In some ways, transactors follow a similar path to disengagement as revolvers. Since they do not carry balance over between months, however, there is often a reduced “lag time” between sales inactivity and statement inactivity.

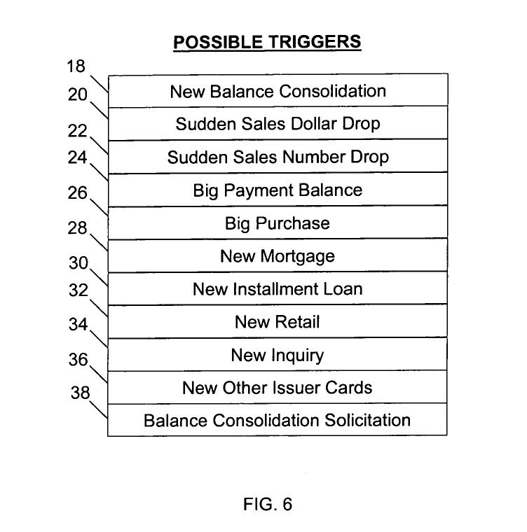

In some embodiments, one can also look for triggers that precede inactivity. FIG. 6 is a table that illustrates examples of possible triggers for new balance consolidations and new off-us cards for embodiments of the invention. Examples of possible triggers include, new balance consolidation 18, sudden sales dollar drop 20, sudden sales number drop 22, big payment balance 24, big purchase 26, new mortgage 28, new installment loan 30, new retail 32, new inquiry, 34, new other issuer card 36, and balance consolidation solicitation 38. Some trigger analysis shows that the sales activity reduction has correlation with certain triggers, albeit often not a strong one. For example, customers can be more likely to take new balance consolidation 18 or open new other-issuer cards (i.e., opening new credit card accounts from other-issuers) 36 during the period of sales slowdown. Some comparisons between a set of customers who have become severely disengaged from the issuer's products and services versus those who are not, show that these triggers tend to be part of the “noises” in the earlier stages of the sales deterioration.

Borrowing terminology from the field of debt collection, in embodiments of the present invention, one may divide customers into “buckets. In debt collection, these buckets are known as delinquency buckets, but the division of customers into buckets for embodiments of the invention is based on where they are in the process of becoming disengaged from the card issuer's products and services.

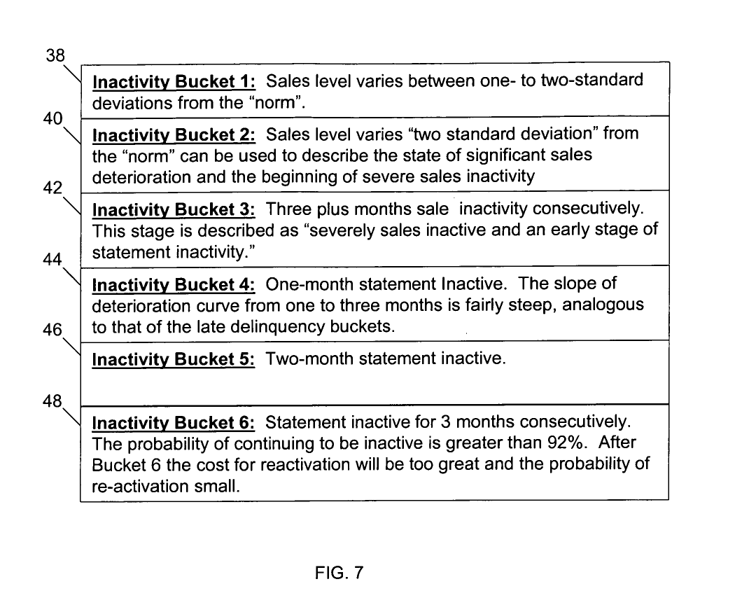

FIG. 7 is a table that illustrates examples of inactivity buckets for embodiments of the invention. Referring to FIG. 7, embodiments of the invention divide customers, for example, into inactivity buckets one 38 through six 48. In one analysis using an embodiment of the present invention, it was found that once a customer is statement inactive for three consecutive months, the probability of continuing in that state is about 90%. The slope of a deterioration curve from one-month statement inactive to three-months statement inactive is fairly steep, analogous to that of late-stage delinquency buckets.

Therefore, according to embodiments of the invention, this stage of becoming severely inactive is labeled as inactivity buckets four 44 through six 48, with one month of statement inactive status falling in inactivity bucket four 44, two consecutive months of statement inactive statue falling in inactivity bucket five 46, and three consecutive months of statement inactive status falling in inactivity bucket six 48. That is because once an account has been statement inactive for three-months, the cost for reactivation will likely be too great and the probability of success likely too small. It is to be noted that in one analysis, 87% of accounts that were in bucket six 48 as of at a particular point in time remained in bucket six one year later. This emphasizes the importance of intervening earlier in the customer's path to inactivity.

The path analysis for embodiments of the invention also shows that statement inactivity is often preceded by a stage of continuous sales deterioration. Once a customer has been sales inactive for three months or more, the probability of becoming statement inactive is about 50%. The percentage of customers who are statement inactive tends to increase as the customers continue down the sales inactive path. This stage of severe sales inactivity and the beginning of statement inactivity is labeled inactivity bucket three 42.

Further analysis according to embodiments of the invention shows that even prior to inactivity bucket three 42, customers' usage have often shown a significant departure from the “norm” or prior behavior after detrending seasonality (i.e., adjusting the data to compensate for seasonal sales variations, such as higher sales historically occurring during the December holiday season). A two standard deviation from the norm can be used to describe the state of significant sales deterioration and the beginning of severe sales inactivity which is labeled inactivity bucket two 40.

In an early stage of sales deterioration, which is labeled inactivity bucket one 38 according to embodiments of the invention, the sales level often varies, for example, between one to two standard deviations. This stage is also accompanied by frequent occurrences of triggers. The bucket one stage 38 of inactivity describes the state in which customers are subject to many influences and treatments from the market and are in the process of considering whether they should maintain their preference for the existing card products and services.

Finally, normal and active credit card usage is represented by bucket zero (not shown).

As a means of reference of potential business lost, in one analysis using an embodiment of the invention, it was found that customers with accounts in buckets four 44 and higher hold accounts with a combined total value of billions of dollars on cards issued by other credit card issuers (also referred to herein as “other-issuer” cards). In this analysis, as accounts progress into inactivity buckets, the issuer begins to lose wallet share and all the share when an account is in bucket four 44.

In embodiments of the invention, the issuer analyzes customer usage levels, and then ascertains what the confidence level of the prediction of future inactivity is for the different buckets (in some embodiments, in combination with other indicators, such as triggers). The issuer can then make a determination of whether or not to intervene for a given customer or group of customers based, for example, on their lifetime value to the issuer and on the strength of the prediction of inactivity.

The path to inactivity and inactivity bucket definition in general can provide a framework in which sales activation may be managed proactively from early-on. In some embodiments, the earlier buckets of inactivity (e.g., buckets one 38 through three 42) offer an issuer opportunities for a proactive management process. Analysis on still earlier stages (e.g., buckets one 38 and two 40) indicates that the deterioration or variation may be measured and managed which could be particularly valuable in managing high value segments. In some embodiments, rather than managing potential causes (i.e., triggers), the alternative can be to monitor the levels of deterioration and the departure from the norm and understand the “voice of the customers” for the right action.

The above-described embodiments of the present invention are not the only embodiments thereof. The described inactivity buckets are one way of grouping customers whose credit card usage is being analyzed and who may be at risk of becoming disengaged from the credit card issuer's products and services, but not the only or required way. While using the methodology of embodiments of the present invention to analyze accounts, issuers can group customers in many different ways, without departing from the scope of the present invention.

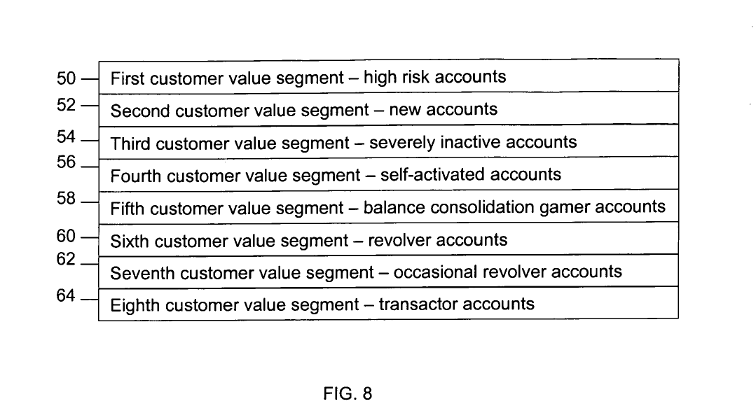

Another aspect of embodiments of the invention involves, for example, evaluation of customer value and division of customers into customer value segments, which allows the issuer to more specifically tailor the analysis and subsequent actions to the particular customer. FIG. 8 is a table which illustrates an example of customer value segments for embodiments of the invention. Referring to FIG. 8, the value segments for this aspect include, for example, a first customer value segment 50 that contains high risk customers, a second customer value segment 52 that contains new accounts, a third customer value segment 54 that contains severely inactive accounts, a fourth customer value segment 56 that includes the self-activated population, a fifth customer value segment 58 that includes the balance consolidation gamer customer population, a sixth customer value segment 60 that includes the revolver customer population, a seventh customer value segment 62 that includes the occasional revolver population, and an eighth customer value segment 64 that includes the transactor population.

As noted above, the first customer value segment 50 for embodiments of the invention contains high risk customers. A feature of the first customer group is that at least 10% of the customers in it are projected to have their debt written off within the next twelve months due, for example, to bankruptcy or other non-payment of debt. This situation is also referred to as customers having an account loss rate of 10% or more.

As also noted above, the second customer value segment 52 for embodiments of the invention contains new accounts (i.e., accounts up to one year old). New accounts may be further subdivided by their age within this one year period. New accounts with less than three months of business generally do not display stable enough behavior to be further evaluated. New accounts with four to five months of business can be divided into: low sales which includes, for example, less than $250 worth of sales per month, high sales which includes, for example, more than $250 worth of sales per month, sales inactive, and statement inactive.

In some cases, a card issuer can predict certain aspects of a customer's future behavior from early-on according to embodiments of the invention. Thus, based on a customer's first three months or first six months of behavior, an issuer can largely tell what kind of behavior he or she would have as a long-term customer (i.e., after they migrate to the existing customer side). Specifically, the customer's activity during these months enables the issuer to predict the customer's future usage pattern, such as whether the customer is likely to be a transactor or to engage principally in balance consolidation. However, it is typically not possible to predict the customer's payment behavior.

In embodiments of the invention, new accounts with six to twelve months of business generally have enough data associated with them to permit further analysis and may be subdivided, for example, into gamers, sales only, balance consolidation and sales, balance consolidation only, and inactive accounts. Gamers are customers who engage in balance consolidation (or “balcon”) only, with little or no sales even when their utilization is below their comfort zone. A customer's comfort zone is defined herein as the customer using no more than 70% of the credit limit on a given credit card. Most customers will refrain from using a given credit card if they exceed this level.

According to embodiments of the invention, new account garners generally make poor customers from the issuer's point of view. At a point 18 months after balance consolidation, which is synonymous with account opening for new customers, their sales activation rates, monthly sales, non-promotional balances, and, ultimately, business income, are much lower than those of non-gamer populations. New account gamers' rate of statement inactivity is also higher compared to non-gamer new accounts. Customers that continue to do only balance consolidation often have extremely high closure and statement inactive rates in years two and three. Their lifetime value is often negative given the existing balance consolidation offers.

In embodiments of the invention, sales only customers are likely to become loyal, high value customers. Though the involuntary closure rate can be high in this subsegment, the survivors tend to be loyal and profitable.

Customers engaged in both balance consolidation and sales have the potential to evolve into profitable revolvers according to embodiments of the invention. Accounts engaged in both sales and balance consolidation in the first year are composed of very loyal and risky customers. Transactor/light revolvers tend to start with sales and engage in balance consolidation along the way. This group as a whole is often very vulnerable to losses. At the same time, the survivors look like loyal customers. Revolvers tend to start with both balance consolidation and sales. Due to the significant added balances, the lifetime value of these customers is often also very profitable.

According to embodiments of the invention, accounts that started with balance consolidation but later engaged in sales tend to have a much lower level of sales compared to the average. The lifetime value is generally low for these customers due to low sales, funding of the promotional balances during the first year, as well as the deterioration of the population. For example, 40% of customers in this segment have closed or had their accounts closed by the third year of card membership, and 60% of customers in this segment are severely inactive by that time, although their accounts may still be open.

In embodiments of the invention, balance consolidation-only accounts include customers who engage only in balance consolidation with utilization above their comfort zone.

According to embodiments of the invention, inactive accounts include accounts that are likely to remain inactive for the life of the account. Even if initially inactive accounts begin to become active at a later date, the general activity level (i.e., sales and balance) tends to be low. When accounts engaged in balance consolidation and added significant balances, the low sales level tend to bring down their average life-time value as well.

In an analysis according to an embodiment of the invention, it was found that only about 12% of the new accounts survived the first year and become very engaged with the issuer in the next 12 months. In one analysis, from acquisition to existing card member (“ECM”), this translates into the fact that at any given point in time, the current ECM portfolio would have about several million accounts that have actively engaged with the issuer through transactions for the past 12 months.

As previously noted, the third customer value segment 54 for embodiments of the invention contains severely inactive accounts. These accounts may be further subdivided, for example, into never active, gamer, off-us or other issuer revolvers, and off-us or other issuer transactors subsegments. The never active subsegment includes, for example, accounts with no lifetime purchase or cash advances or account balance. The gamer subsegment includes, for example, accounts that have come through both acquisition and ECM balance consolidation offers. The other-issuer revolvers subsegment includes, for example, customers of high, medium, and low potential, but whose revolver activity is limited or principally limited to credit cards issued by other banks.

The other-issuer transactor subsegment for embodiments of the invention includes, for example, customers who use their credit cards according to the transactor usage pattern but whose activity is limited or principally limited to credit cards issued by other banks. These customers may also maintain a steady balance over time. In one analysis using an embodiment of the invention, it was determined that 38% of the severely inactive population are potential revolvers with high potential. It was further determined that the other-issuer transactor subsegment makes up 45% of the severely inactive population and usually have low other-issuer balances and a declining trend in other-issuer balances.

As also previously noted, the fourth customer value segment 56 for embodiments of the invention contains, for example, the self-activated population. These customers were earlier inactive with regards to the issuer's credit card but have since become active. In the period of time preceding the start point of the analysis according to embodiments of the invention (the “pre-period”) there is insufficient data to evaluate their behavior, but in the time period where analysis according to the present invention is possible and performed (the “post-activity period”), the customers may be divided, for example, into a revolver-like subsegment who either have a sizable other-issuer balance or a growing other-issuer balance over a given time period, such as six months, and a transactor-like subsegment who have a smaller and steady other-issuer balance.

The fifth customer value segment 58 for embodiments of the invention, as likewise previously noted, contains, for example, the balance consolidation gamer customer population. This segment may be further divided, for example, into lifetime gamers and ECM garners subsegments. The lifetime gamers subsegment contains the lifetime gamer customers and is characterized by customers with balance consolidation history but with no lifetime interest payment. The lifetime gamer customers further tend to become statement inactive after the expiration of their promotional period. In one analysis using an embodiment of the invention, it was found that less than 5% of lifetime garners are sales active, accounting for their minimal accumulation of non-promotional balances of the group as a whole. It was further determined that 90% of lifetime garners become statement inactive after balance consolidation paydown.

The ECM garners subsegment for embodiments of the invention contains the existing card member or ECM gamer customers and is characterized by more than twelve months of business and engagement in balance consolidation only, with little or no sales even when utilization is below the customer's comfort zone. ECM gamer customers are typically sales inactive during the promotional period and tend to remain sales inactive after the promotional period. In one analysis using an embodiment of the invention, only 10% of ECM garners are sales active, with average monthly sales of $50-100. Overall, gamers are much less profitable to the issuer than other balance consolidation customers.

The sixth customer value segment 60 for embodiments of the invention contains, for example, the revolver customer population, characterized by consistently having activity on the card and revolving (i.e., carrying a balance) every month in the pre-period. Customers in this value segment may be further subdivided, for example, into a high value subsegment in which the issuer's credit card is used for transactions at least five out of six months, a mid-value subsegment in which the issuer's credit card is used for transactions at between two to four months out of six months, and a low value subsegment in which the issuer's credit card is used for transactions one or fewer months in a six months period.

The seventh customer value segment 62 for embodiments of the invention contains, for example, the occasional revolver population, characterized by alternating between paying their balance in full and revolving in the pre-inactivity period. This segment may be further subdivided into a revolver-like subsegment, which has significant other-issuer balances, and a transactor-like subsegment, which has no significant other-issuer balances.

The eight customer value segment 64 for embodiments of the invention contains, for example, the transactor population, which customers are characterized by consistently paying their bills in full in the pre-inactivity period. This value segment may be further divided, using the same criteria as the revolver value segment for example, into a high value subsegment in which the issuer's credit card is used for transactions at least five out of six months, a mid-value subsegment in which the issuer's credit card is used for transactions at between two to four months out of six months, and a low value subsegment in which the issuer's credit card is used for transactions one or fewer months in a six months period.

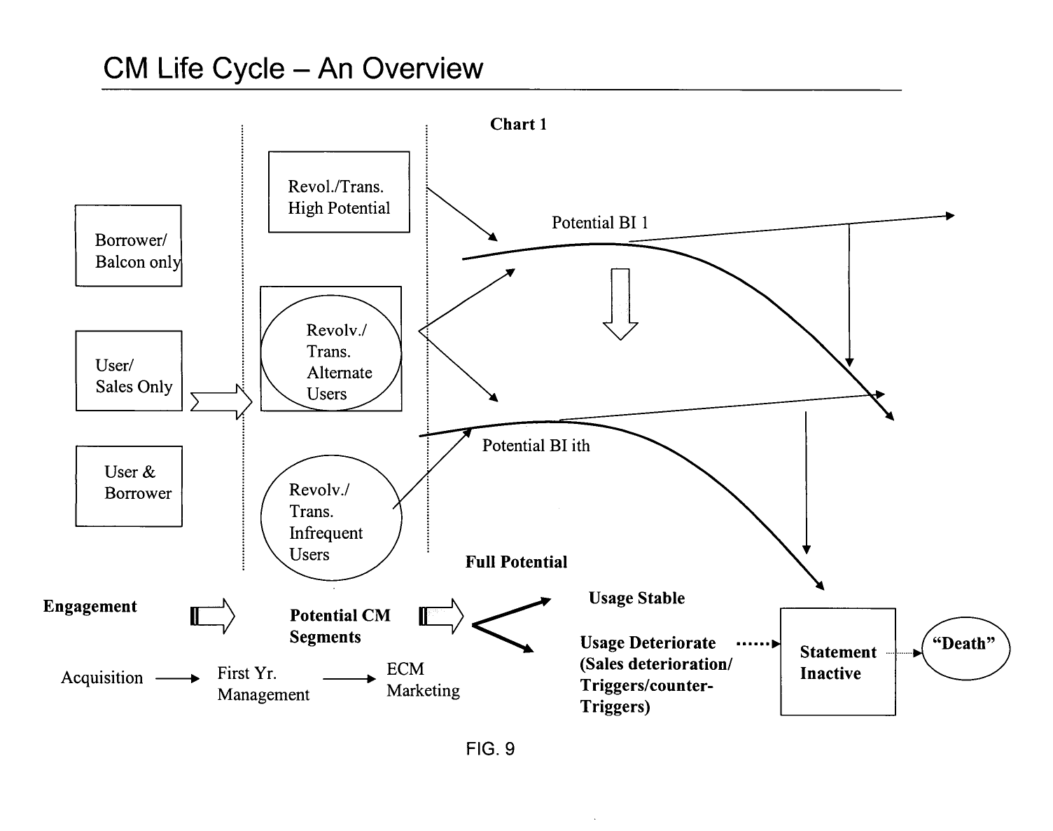

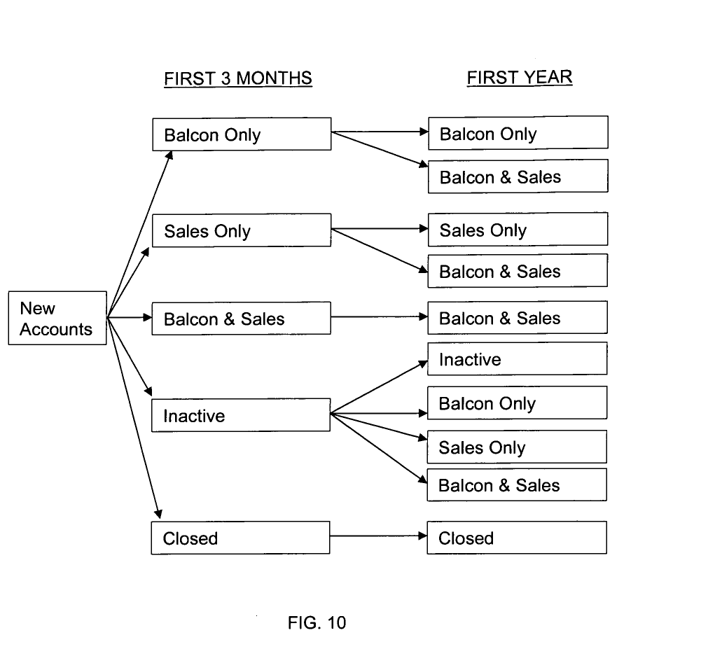

Embodiments of the invention can take on a “customer lifecycle” point of view which begins from new account acquisition. FIG. 9 is a schematic diagram that illustrates an example of a transaction card customer life cycle for embodiments of the invention, and FIG. 10 is a table that illustrates examples of customer transaction patterns for embodiments of the invention. A customer's engagement with a card issuer's products or services during the first few months can be predictive of the customer life cycle in general. First year survivors tend to be those who have actively engaged in sales or both sales and lending at the very beginning. Once they enter the ECM stage, “loyal customers” who transact frequently also usually demonstrate a higher lifetime value.

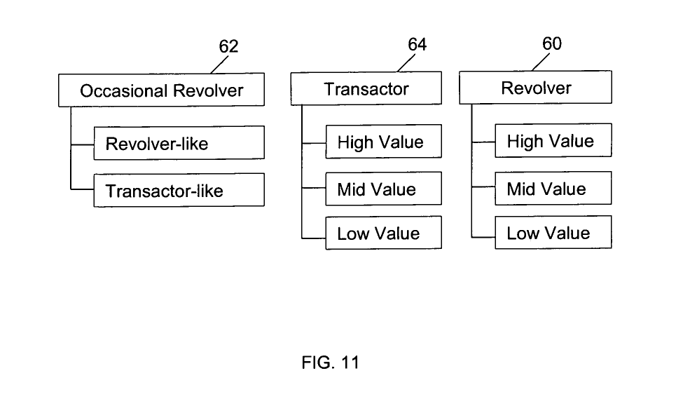

In some embodiments of the present invention, the customer value segments eligible for proactive sales management by the issuer are the occasional revolver 62, the transactor 64, and the revolver segments 60. FIG. 11 is a table that illustrates an example of customer value segments and subsegments eligible for proactive sales management for embodiments of the invention.

Embodiments of the invention provide strategies for re-engaging customers at risk for inactivity. The previously-noted comparison between inactivity buckets and delinquency buckets suggests that inactivity can be managed in a similar framework as debt collection.

In embodiments of the invention, due to the complexity and volatility of the usage behavior in inactivity bucket one 38, and hence the greater uncertainty of outcome, it is critical to recognize that customers do not have the same lifetime value, and when they depart from the existing preference, the opportunity costs for the issuer are not the same. When loyal/high potential customers depart, the business opportunity costs are often much greater than when customers who have used their cards infrequently, and probably would continue the same usage even if they do not change their existing preference, depart. Therefore, in some embodiments, the challenge is to define the underlying customer segments, as has been described previously herein, defining their potential and evaluating the opportunity cost for the issuer when customers depart from their potentials. This process is further elaborated below.

Almost any form of action by the credit card issuer is an expense for the issuer. Therefore, in embodiments of the invention, an assessment can be made of whether or not the potential business opportunity cost of an account becoming inactive justifies the expense of active intervention by the issuer. That is to say, the issuer can evaluate the cost-to-benefit ratio of intervening to re-engage the customer for customers who are becoming disengaged and whose accounts are likely to become inactive.

In embodiments of the invention, customer valuation is important to prioritize the investment process. During the very early stages of the inactivity, the variations in sales and higher rollback rate (rollback rate being defined as the reversal of the deterioration trend; e.g., if 10% of customers in inactivity bucket two 40 exhibited increased activity and moved to inactivity bucket one 38, the rollback rate for inactivity bucket two 40 would be 10%) may also impose challenges in correctly identifying the potential deteriorating segment, which could greatly increase the marketing opportunity costs. The concept of customers' life time value is often important in the valuation and prioritizing of the investment. In one example, “loyal” customers are active for a long period of time and their sales levels remain fairly stable, but the investment return is significant for revolvers due to the balance built by sales.

In one embodiment of the present invention, the issuer can begin by targeting population in bucket three 42 and test into high potential customers in the earlier buckets of deterioration to learn their way into the proactive management process.

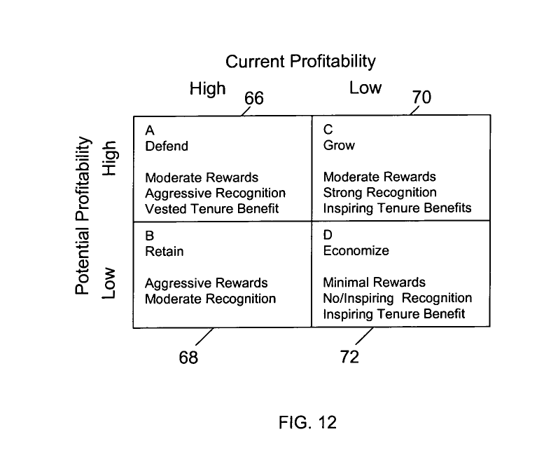

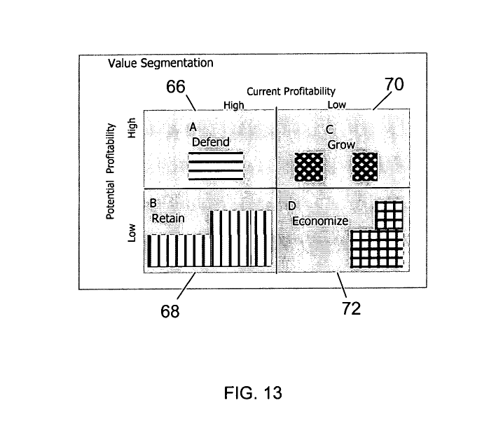

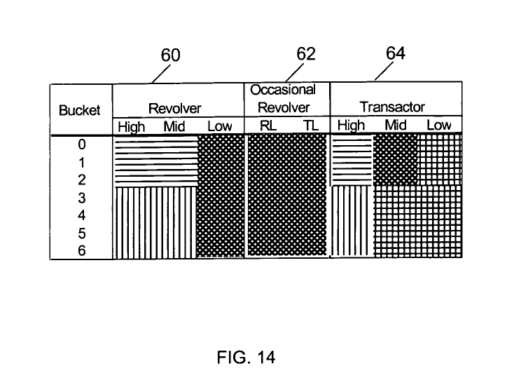

In another embodiment of the present invention, one can make a matrix of the transactor 64 and revolver 60 customer segments, cross referenced with the inactivity buckets to guide application of proactive sales management to determine the issuer's marketing and investment strategies. FIG. 12 is an example of a graphical illustration of appropriate strategies to defend 66, retain 68, grow 70, or economize 72, based on an evaluation of customers' current and potential profitability, for embodiments of the invention. FIG. 13 is a similar graphical illustration with legends representing each of the defend 66, retain 68, grow 70, and economize 72 strategies for embodiments of the invention. FIG. 14 is a graphical illustration with legends corresponding to FIG. 13 of appropriate strategies for the revolver 60, occasional revolver 62, and transactor 64 customer value segments for action by the credit card issuer for embodiments of the invention.

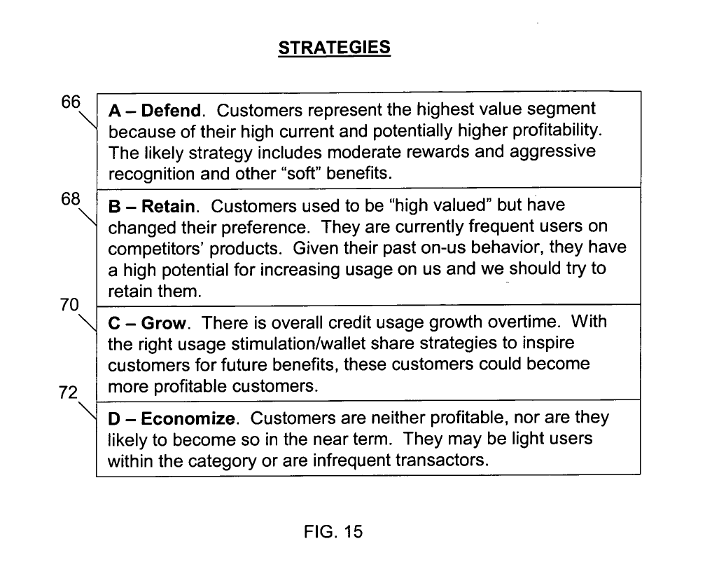

Referring to FIGS. 12-14, accounts that are eligible for proactive sales management according to embodiments of the invention are located onto the matrix of FIG. 14 based on the customer's activity status (i.e., inactivity buckets zero through six), the customer's credit usage pattern (i.e., high, mid, or low revolver; revolver-like or transactor-like occasional revolver; or high, mid, or low transactor), and the customer's potential and current profitability (high or low). Each location on the matrix is, in turn, associated with a particular recommended strategy for proactively managing the customers selected, for example, from a group of strategies consisting at least in part of defend 66, retain 68, grow 70, and economize 72 for implementation by the issuer. FIG. 15 is a table that illustrates examples of recommended strategies based on the analysis for embodiments of the invention.

Referring to FIGS. 12-15, the defend strategy 66 for embodiments of the invention pertains, for example, to customers representing the highest value segment because of their high current and potentially higher profitability. If customers in this segment appear to be at risk for disengagement with the issuer's credit card, the issuer should take action to prevent them from leaving. The likely strategy includes moderate rewards and aggressive recognition and other “soft” benefits. The retain strategy 68 for embodiments of the invention relates to customers who used to be high valued but have changed their behavior and are thus no longer as valuable to the issuer. They currently may be frequent users of competitors' products and services. Given their past on-issuer behavior, they have a high potential for increasing usage of the issuer's products and services, and the issuer should try to retain them.

Referring again to FIGS. 11-14, the grow strategy 70 for embodiments of the invention applies to customers for whom there is overall credit usage growth over time. With the right usage stimulation/wallet share strategies to inspire customers for future benefits, these customers could become more profitable customers. The economize strategy 72 for embodiments of the invention pertains to customers who are neither profitable, nor are they likely to become so in the near term. They may be light users within the category or are infrequent transactors.

Several different customer characteristics can contribute to the prediction of a customer's lifetime value, including level of potential, transactor/revolver and usage stability. From a cohort perspective, in one analysis using an embodiment of the present invention, it was found that non-deteriorate customers' usage is relatively stable over time. Customers who either have very infrequent usage or very frequent usage tend to stay that way. Customers in the middle tend to migrate both ways with a consistent range. Customers who have used their cards less frequently tend to slide towards less usage while customers who have used their cards more frequently tend to migrate toward more frequent usage. Therefore, not all customers are loyal customers who would use their cards every month.

In one analysis using an embodiment of the present invention, it was found that when customers remain engaged, their usage frequency tends to be relatively stable. In addition, their overall usage is also fairly stable. Loyal customers who have remained sales active tend to have fairly stable levels of sales over time except, for example, for seasonalities. Transactors in general also tend to have fairly stable balances, while revolvers would grow their balance at about 13% annually. Business income (BI) and return on total assets (RoTA) for these customers also tend to be stable and slightly trending up.

Therefore, for loyal customers, according to embodiments of the invention, it is often reasonable to assume that if they remain loyal, their lifetime value is stable and can be estimated. This estimate forms the basis of the lifetime value estimate of the customer. The higher the lifetime value of a customer, the earlier or more aggressive intervention by the issuer can be justified.

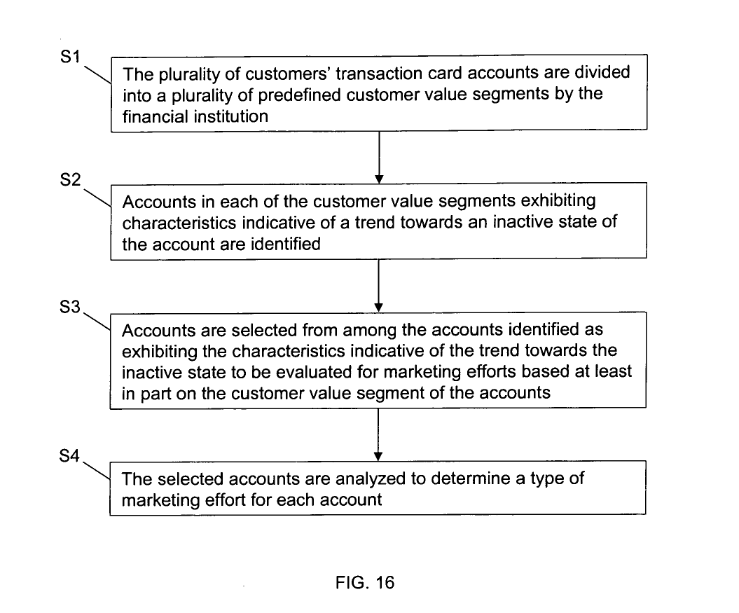

An embodiment of the present invention includes a series of decisions, wherein data is evaluated at each point for advancement to the next decision point. FIG. 16 is a flow chart that illustrates an example of the process of managing transaction card customer accounts for embodiments of the invention. Referring to FIG. 16, At S1, the plurality of customers' transaction card accounts are divided into a plurality of predefined customer value segments by the financial institution, and at S2, accounts in each of the customer value segments exhibiting characteristics indicative of a trend towards an inactive state of the account are identified. Thereafter, at S3, accounts are selected from among the accounts identified as exhibiting the characteristics indicative of the trend towards the inactive state to be evaluated for marketing efforts based at least in part on the customer value segment of the accounts. At S4, the selected accounts are analyzed to determine a type of marketing effort for each account.

An example of such a decision-making process for embodiments of the invention involves, for example, dividing the customers' credit card accounts into customer value segments, based on their usage history and pattern, and deciding which segments are eligible for proactive sales management based, for example, on their potential value. Accounts in the selected segments are then further analyzed.

Thereafter, according to embodiments of the invention, the information is analyzed for a given account by first looking to see if one of the variables has changed in a manner that suggests that the customer is trending towards inactivity on the issuer's credit card. In some embodiments, such variables may include a change in sales levels or a trigger, or a combination thereof. If a variable has changed in a manner suggesting that the customer is trending towards inactivity (e.g., a statistically significant change in the level of sales activity), the account is further evaluated as described below.

Continuing with the example for embodiments of the invention, an evaluation is made of whether or not the particular account is eligible for marketing. This evaluation may be based on which customer value segment the account is in, the issuer's risk management criteria, and/or the issuer's marketing criteria.

If this evaluation indicates that the account is eligible for marketing, according to embodiments of the invention, the account is further analyzed and evaluated to determine what particular marketing offer or offers it is eligible and best suited for. This analysis is based on factors such as the stage of deterioration (i.e., inactivity bucket) the account is in, the customer's usage pattern, and the customer's value. This step may be referred to as the treatment area or treatment decision area. The account information and analysis can then be forwarded to offer treatment personnel or an offer treatment department, either of which can be off line. Specific criteria can be accumulated through testing, such as profit and loss (P&L), exercises, and the like.

Based on the foregoing analysis for embodiments of the invention, a decision is made regarding what form of offer or other intervention is appropriate. For example, for a particularly high value account, it may be appropriate to make personal contact with the customer over the phone in to obtain information directly from the customer instead of communicating in writing in order to have a higher likelihood of success. When the decision is made as to what form of offer or other intervention is appropriate, the intervention deemed appropriate is implemented.

In embodiments of the invention, many of the foregoing steps, especially those looking for indicators of future customer inactivity, can be automated until human intervention is needed, bringing benefits such as speed, while at the same time providing a more detailed analysis as to whether or not intervention to the customer is needed.

Embodiments of the invention can be implemented as processes of a computer program product; each process of which is operable on one or more processors either alone on a single physical platform, such as a personal computer, or across a plurality of platforms, such as a system or network, including networks such as the Internet. Such a system can comprise multiple client devices in communication with one or more server devices over a network. In one embodiment, the network comprises the Internet. In other embodiments, other networks, such as an intranet, WAN, LAN, or cellular network may be used. In yet other embodiments, other suitable networks may be used.

The client devices each comprises a computer-readable medium, such as a random access memory (RAM) coupled to a processor. The processor executes computer-executable program instructions stored in memory. Such processors may comprise a microprocessor, an ASIC, and state machines. Such processors comprise, or may be in communication with, media, such as computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor of the client, with computer-readable instructions.

Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other suitable medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

The client devices may also comprise a number of external or internal devices such as a mouse, a CD-ROM, DVD, a keyboard, a display, or other input or output devices. In general, a client device may be any suitable type of processor-based platform that is connected to a network and that interacts with one or more application programs. Client devices may operate on any suitable operating system, such as Microsoft® Windows® or Linux.

Server devices are also coupled to the network. Similar to the client devices, the server devices comprise a processor coupled to a computer-readable medium, such as a random access memory (RAM). The server device, which can be a single computer system, may also be implemented as a network of computer processors. Examples of a server device are servers, mainframe computers, networked computers, a processor-based device, and similar types of systems and devices. Client processor and the server processor can be any of suitable number of computer processors, such as processors from Intel Corporation of Santa Clara, Calif. and Motorola Corporation of Schaumburg, Ill. Alternatively, methods according to the present invention may operate within a single computer. An embodiment such as the one described above could be implemented as a decision engine which may be largely automated and collect data on the accounts from multiple sources.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A method for managing transaction card customer accounts, comprising:
providing transaction card accounts for a plurality of customers by a financial institution;
dividing the plurality of customers' transaction card accounts into a plurality of predefined customer value segments by the financial institution;
identifying accounts in each of the customer value segments exhibiting characteristics indicative of a trend towards an inactive state of the account;
selecting accounts from among the accounts identified as exhibiting the characteristics indicative of the trend towards the inactive state to be evaluated for marketing efforts based at least in part on the customer value segment of the accounts; and
analyzing the selected accounts to determine a type of marketing effort for each account.

2. The method of claim 1, wherein dividing the accounts further comprises dividing the accounts into the plurality of predefined customer value segments based at least in part on predefined parameters related to a potential value of each customer's account to the financial institution.

3. The method of claim 2, wherein dividing the accounts based at least in part on the predefined parameters related to the potential value of each customer's account further comprises dividing the accounts based at least in part on a predefined potential business income contribution to the financial institution from each customer's account.

4. The method of claim 1, wherein dividing the accounts further comprises dividing the accounts into the plurality of predefined customer value segments based at least in part on how often a customer uses the customer's account in a predetermined time period

5. The method of claim 1, wherein dividing the accounts further comprises dividing the accounts into customer value segments consisting at least in part of a predefined transactor segment and a predefined revolver segment.

6. The method of claim 5, wherein dividing the accounts further comprises dividing the accounts into customer value segments consisting at least in part of a transactor segment of customers who use their transactions cards for sales and pay their balances in full and a revolver segment of customers who do not pay their balances in full and carry a balance on their account.

7. The method of claim 6, wherein dividing the accounts into customer value segments consisting at least in part of the transactor segment and the revolver segment further comprises assessing each account in the transactor and revolver segments as one of a high value, mid value or low value customer according to predefined parameters.

8. The method of claim 7, wherein assessing accounts in the transactor and revolver segments as one of a high value, mid value or low value customer further comprises assessing a customer in the transactor or revolver segment as a high value customer if the customer uses the customers' account at least five months in a six months period.

9. The method of claim 7, wherein assessing each account in the transactor and revolver segments as a high value, mid value or low value customer further comprises assessing a customer in the transactor or revolver segment as a mid value customer if the customer uses the customer's account for two to four months in a six months period

10. The method of claim 7, wherein assessing each account in the transactor and revolver segments as a high value, mid value or low value customer further comprises assessing a customer in the transactor or revolver segment as a low value customer if the customer uses the customer's account for one or fewer months in a six months period

11. The method of claim 6, wherein dividing the accounts into customer value segments further comprises dividing the accounts into at least one additional predefined customer value segment consisting of occasional revolvers characterized by customers who alternate between paying their balance in full and revolving their balance.

12. The method of claim 11, wherein dividing the accounts into customer value segments further comprises dividing the accounts into additional predefined customer value segments consisting of any of high risk customers, new accounts, severely inactive accounts, self-activated accounts, balance consolidation gamers, and occasional revolvers.

13. The method of claim 1, wherein identifying the accounts exhibiting characteristics indicative of a trend towards the inactive state further comprises identifying accounts in each of the customer value segments exhibiting a change in a level of sales indicative of the trend towards the inactive state of the account.

14. The method of claim 13, wherein identifying the accounts exhibiting characteristics indicative of a trend towards the inactive state further comprises identifying accounts in each of the customer value segments exhibiting a change in the level of sales as a function of time indicative of the trend towards the inactive state of the account.

15. The method of claim 14, wherein identifying the accounts in each of the customer value segments exhibiting a change in the level of sales as a function of time further comprises dividing the identified accounts into buckets based at least in part on a level of inactivity in each account.

16. The method of claim 15, wherein dividing the accounts into buckets based on levels of inactivity further comprises dividing the accounts into buckets based on levels of inactivity in each account ranging from statement inactivity for three consecutive months to sales levels varying less than one standard deviation from a mean for the account.

17. The method of claim 15, wherein identifying the accounts exhibiting the characteristics indicative of a trend towards the inactive state further comprises identifying the accounts before they reach the inactive state.

18. The method of claim 1, wherein selecting the accounts to be evaluated for marketing efforts further comprises selecting the accounts from predefined customer value segments consisting at least in part of a transactor segment of accounts of customers who use their transactions cards for sales and pay their balances in full and a revolver segment of customers who do not pay their balances in full and carry a balance on their account.

19. The method of claim 18, wherein selecting the accounts to be evaluated for marketing efforts further comprises selecting the accounts from at least one additional predefined customer value segment consisting of occasional revolvers characterized by customers who alternate between paying their balance in full and revolving their balance.

20. The method of claim 1, wherein analyzing the selected accounts further comprises analyzing the selected accounts according to a matrix of at least transactor and revolver customer segments, cross referenced with inactivity status.

21. The method of claim 20, wherein analyzing the selected accounts according to the matrix further comprises analyzing the selected accounts based on location onto the matrix of a customer's inactivity status and the customer's value segment.

22. The method of claim 20, wherein analyzing the selected accounts further comprises analyzing the selected accounts according to the matrix to determine a type of marketing strategy consisting of one of a defend strategy, a retain strategy, a grow strategy, and an economize strategy.

23. The method of claim 22, wherein the defend strategy further comprises a strategy for customers representing value and profitability to the financial institution.

24. The method of claim 22, wherein the retain strategy further comprises a strategy for customers formerly representing value and profitability to the financial institution but have changed their behavior and are thus no longer valuable and profitable to the financial institution.

25. The method of claim 22, wherein the grow strategy further comprises a strategy for customers for whom there is overall credit usage growth over time.

26. The method of claim 22, wherein the economize strategy further comprises a strategy for customers who are not profitable and unlikely to become profitable to the financial institution.

27. A system for managing transaction card customer accounts, comprising:
means for providing transaction card accounts for a plurality of customers by a financial institution;
means for dividing the plurality of customers' transaction card accounts into a plurality of predefined customer value segments by the financial institution;
means for identifying accounts in each of the customer value segments exhibiting characteristics indicative of a trend towards an inactive state of the account;
means for selecting accounts from among the accounts identified as exhibiting the characteristics indicative of the trend towards the inactive state to be evaluated for marketing efforts based at least in part on the customer value segment of the accounts; and
means for analyzing the selected accounts to determine a type of marketing effort for each account.
